(19) United States
(12) Patent Application Publication
(10) Pub. No.: US 2004/0059820 A1
(43) Pub. Date: Mar. 25, 2004

(54) Method and apparatus of communications over a network

(75) Inventors: Mark J. Holden, Allen, TX (US); Scott L. Orton, Allen, TX (US); Julie R. Simons, Garland, TX (US)

Correspondence Address: TROP PRUNER & HU, PC, 8554 KATY FREEWAY, SUITE 100, HOUSTON, TX, 77024, US

(73) Assignee: Nortel Networks Limited, St. Laurent (CA)

(21) Appl. No.: 10/424,244

(22) Filed: Apr. 28, 2003

Related U.S. Application Data
(63) Continuation of application No. 09/547,175, filed on Apr. 11, 2000, now abandoned.

(51) Int. Cl. G06F 15/16

(52) U.S. Cl. 709/227

(57) ABSTRACT

A communications system includes a packet-based data network to which are coupled various network elements. At least some of the network elements are capable of participating in real-time interactive communications sessions over the data network. Protocols that provide for such communications sessions include Session Initiation Protocol (SIP) and the H.323 Recommendation. The data network includes subscriber systems that are capable of receiving advertising information in one or more messages communicated from a service provider system over the data network. The service provider system identifies the types of advertising information that may be of interest to one or more users at the subscriber systems. The service provider system is able to receive the advertising information from a data warehouse source, which may collect transaction information, such as retail transaction information, from retail sources. The advertising information provided by the service provider system may include locator information (which may be in the form of an address or uniform resource locator) that a subscriber system may use to establish a real-time interactive communication session with the source of the advertising information.

### BACKGROUND

The invention relates to providing advertising information to users over a data network, and more particularly, to providing advertising information employing messaging according to a real-time interactive communications protocol.

Data networks are widely used to link various types of network elements, such as personal computers, servers, gateways, network telephones, and so forth. Data networks may include private networks (such a local area networks or wide area networks) and public networks (such as the Internet). Popular forms of communications between network elements across such data networks include electronic mail, file transfer, web browsing, and other exchanges of digital data.

With the increased capacity and reliability of data networks, voice communications (including telephone calls, video conferencing, and so forth) over data networks have become possible. Voice communications over data networks are unlike voice communications in a conventional public switched telephone network (PSTN), which provides users with dedicated, end-to-end circuit connections for the duration of each call. Communications over data networks, such as IP (Internet Protocol) networks, are performed using packets or datagrams that are sent in bursts from a source to one or more destination nodes. Voice data sent over a data network typically shares network bandwidth with conventional non-voice data (e.g., data associated with electronic mail, file transfer, web access, and other traffic).

The flexibility and convenience of data networks, including the Internet, has led to a rapid increase in many forms of business transactions over data networks. Such transactions are sometimes referred to as web-based electronic commerce or e-commerce transactions. Many businesses offer various products and services (e.g., travel services, sales of office supplies, stock trading services, and others) that are available over the Internet. Associated with such sales of services and goods over the Internet is advertising on web pages. Thus, when a user enters a web page, he or she may be presented with advertising (usually in the form of advertisement banners) from various sources. By clicking on the advertisement banners in these web pages, the user can go to the web site associated with the advertising source to learn further information about the products or services that are being offered.

Another mechanism through which advertisers may reach users is electronic mail. With this method, advertisers may periodically send e-mails to users who may be interested in the advertising source's products or services. Yet another more traditional form of advertising includes sending brochures or pamphlets through regular mail.

Although enjoying some level of success, such conventional advertising techniques in many instances have proven not to be effective. Because of the presence of large numbers of advertising banners on a web page, users often ignore such advertising. The same holds true for electronic mail and regular mail advertising materials, which are often discarded by the user without review. Thus, a need for a more effective method and mechanism for providing advertising information to users continues to exist.

### SUMMARY

In general, according to one embodiment, a method of providing advertising information over a network includes receiving the advertising information associated with a source, the advertising information including locator information associated with the source. In response to user input, a request based on the locator information is sent to establish a real-time interactive call session with the source.

In general, according to another embodiment, a method of providing advertising information over a network includes receiving advertising information from a source, identifying the advertising information for a given user, and sending over the network the identified advertising information to one or more subscriber systems associated with the given user. The identified advertising information is sent employing messaging according to a real-time interactive communications protocol.

Some embodiments of the invention may have one or more of the following advantages. A more effective technique is provided for conveying advertising information to users. Such advertising information may be transmitted to devices that are capable of participating in real-time interactive call sessions. Thus, if the user so desires, the user may initiate, in response to receipt of the advertising material, a real-time interactive call session with the source of the advertising information to purchase the advertised product or service. The address of the advertising source may be included in the advertising material to facilitate the initiation of the real-time interactive call session.

Other features and advantages will become apparent from the following description, from the drawings, and from the claims.

### BRIEF DESCRIPTION OF THE DRAWINGS

FIG. 1 is a block diagram of an embodiment of a communication systems including a packet-based data network coupled to various network elements, including subscriber systems that are capable of establishing real-time interactive call sessions, such as Session Initiation Protocol (SIP) call sessions.

FIG. 2 is a block diagram of a subscriber system in accordance with one embodiment.

FIG. 3 is a block diagram of a service provider system in accordance with one embodiment.

FIG. 4 is a flow diagram of a process performed by the service provider system of FIG. 3 in communicating advertising information to selected subscribers.

FIGS. 5A-5B illustrate example message flows for providing advertising information in accordance with some embodiments.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible. Although reference is made to the Session Initiation Protocol or the H.323 Recommendation in the described embodiments, further embodiments may include other types of protocols or standards for establishing real-time interactive call sessions.

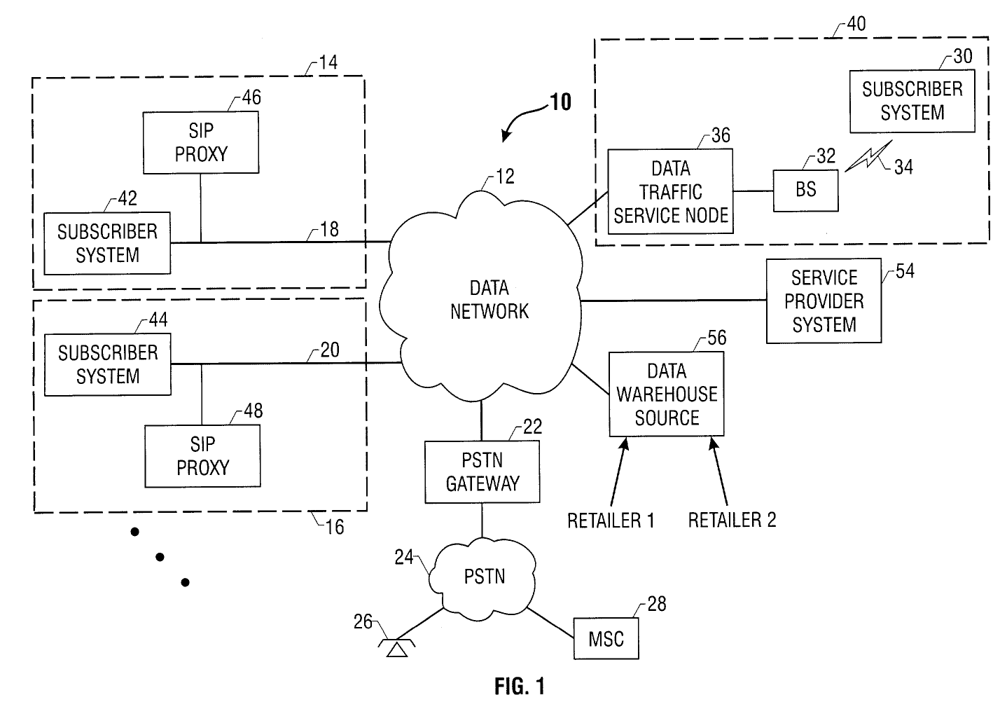

Referring to FIG. 1, a communications system 10 includes a packet-based data network that may be coupled to various local systems (14, 16, and 40 illustrated). The local systems 14 and 16 include local networks (e.g., local area networks) 18 and 20 that are coupled to various network elements (42 and 44 illustrated). Such network elements are capable of participating in real-time interactive call sessions over the local networks 16 and 20 and the data network 12. While the systems 14 and 16 include wired local networks 18 and 20, the system 40 (e.g., a cellular system) may include a wireless local network coupled to a network element 30 (which may be a mobile device). In the ensuing description, the wired and wireless local networks and the data network 12 may be collectively referred to as “the data network 12.”

A service provider system may also be coupled to the data network 12. The service provider system 54 may maintain a list of subscribers or users who have subscribed through the service provider to access predetermined features offered over the data network 12. For example, the service provider system 54 may enable Internet access, call sessions using SIP (Session Initiation Protocol) or H.323, and other services for network elements 42, 44, and 30. Based on the monitored usage, the service provider system 54 may send periodic bills to its subscribers.

In accordance with some embodiments, one of the services that the service provider system 54 provides is the communication of advertising information to its subscribers who have indicated an interest to receive such advertising information. The advertising information is sent to subscriber systems (including network elements 42, 44, and 30) associated with the subscribers. As used here, a “subscriber system” refers to any device or system that may be used by a subscriber or user to perform communications over the data network 12.

A service provider may have negotiated a deal with some of its subscribers in which the subscriber receives a discount or free services in return for accepting various forms of advertising material. The service provider system 54 may have access to a data warehouse source 56 over the data network 12 that collects transactions from various retailers. Alternatively, the data warehouse source 56 may be coupled to the service provider system 54 over a dedicated link. The data warehouse source 56 may sort the transactions by user so that the service provider system 54 may periodically send advertising material to its interested subscribers.

Generally, a data warehouse may include copies of transaction data (e.g., retail transaction data) that have been structured for query and analysis or reporting. The retail transaction data may track purchases made by the users of goods and services from participating retail sources. The data warehouse source 56 may also receive advertising information from the retailers. Such advertising information may be in various forms, e.g., audio format, audio/video format, image format, or markup language file format (such as Hypertext Markup Language or Extensible Markup Language).

The service provider system 54 is capable of sending queries to the data warehouse source 56 to collect advertising information that may be of interest to a specific subscriber. Report data containing the advertising information, and optionally, the transactions by a user related to the advertising information, may be communicated by the data warehouse source 56 to the service provider system 54. Based on the type of transaction and the date of the transaction, the timing of when to send the advertising information may be determined by the data warehouse source 56 and included with the data report. Alternatively, the service provider system 54 may determine this based on the type and date of the transaction. Thus, for example, if a user purchased a new carpet for his or her home, such a transaction may be communicated to and stored in the data warehouse source 56. Through data warehousing analysis, an indication may be provided that three or four months after the purchase was made, the user may be interested in a carpet cleaning service. Based on such information, the service provider system 54 may send advertising information for carpet cleaning services to the user at one or more systems or devices associated with the user at or around the indicated time. Such systems or devices may include home and office telephones, portable communications devices, computers, and other forms of devices that are capable of receiving SIP messages (or H.323 messages) or participating in SIP call sessions (or H.323 call sessions).

As used here, a “data network” or “network” may refer to one or more communications networks, channels, links, or paths and systems or devices (such as routers) used to route data over such networks, channels, links, or paths. A “call session” refers generally to either an audio (e.g., voice), video, or multimedia session established between two or more network elements coupled to the data network 12 (or any other packet-based data network). An “interactive” call session refers to a call session in which two or more parties are involved in an exchange of audio (e.g., voice) and/or video data in an established session between two or more network elements. A “real-time” interactive call session refers to an exchange of data, such as audio and/or video data, on a substantially real-time basis between two terminals. A session is substantially real-time if interaction is occurring between two end points or parties, with a communication from one end followed relatively quickly by a response or another communications from the other end, typically within seconds, for example.

Interactive call sessions are contrasted with electronic mail messaging, for example, in which a first participant sends a message over a data network to a second participant. No indication is usually provided back to the first participant that the second participant has received the message or that the second participant is even at his or her terminal. In contrast, an interactive call session involves a request followed by some acknowledgment that a called party has accepted the call session. This enables establishment of an interactive call session in which participants exchange data.

In one embodiment, the packet-based data network 12 may include a packet-switched network such as an Internet Protocol (IP) network. One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. Packet-switched data networks such as IP networks communicate with packets, datagrams or other units of data over the data networks. Unlike circuit-switched networks, which provide a dedicated end-to-end connection of physical path for the duration of a call session, a packet-switched network is one in which the same path may be shared by several network elements. Packet-switched networks are based on a connectionless internetwork layer. Packets or other units of data injected into a packet-switched data network may travel independently over any path (and possibly over different paths) to a destination point. The packets may even arrive out of order. Routing of the packets is based on one or more addresses carried in each packet.

In the cellular system 40, the mobile device 30 may be coupled to a base station 32 over a wireless link 34. The base station 32 is in turn connected to a data traffic service node 36. In one embodiment, the data traffic service node 36 may include a serving GPRS support node (SGSN) and a gateway GPRS support node (GGSN) according to the General Packet Radio Service (GPRS) protocol, the Extended GPRS (EGPRS) protocol, or the EGPRS Compact protocol. Through the data traffic service node 36 and the base stations in the cellular system 40, the mobile device 30 is capable of participating in packet-based communications over the data network 12.

The data network 12 may also be coupled through a PSTN gateway 22 to a public switched telephone network (PSTN) 24. Standard non-data network telephones 26 may be coupled to the PSTN 24. A mobile switching center (MSC) 28 may also be coupled to the PSTN 24. The MSC 28 is coupled to base stations that are capable of communicating with mobile devices for circuit-switched communications.

The arrangement illustrated in the FIG. 1 embodiment is as an example only. In other embodiments, other arrangements of elements in the communications system may be possible.

The network elements 42, 44, and 30 in respective local systems 14, 16, and 40 may be capable of participating in SIP call sessions over the data network 12, which may include audio (e.g., voice), multimedia (e.g., audio and video) communications, or communications of other forms of data. SIP is part of the multimedia data and control architecture from the Internet Engineering Task Force (IETF). A version of SIP is described in RFC 2543, entitled “SIP: Session Initiation Protocol,” dated in 1999. SIP may be used to initiate call sessions as well as to invite members to a session that may have been advertised by some other mechanism, such as electronic mail, news groups, web pages, and other mechanisms. The other protocols in the IETF multimedia and control architecture include the Resource Reservation Protocol (RSVP), as described in RFC 2205, for reserving network resources; the Real-Time Transport Protocol (RTP), as described in RFC 1889, for transporting real-time data and providing quality of service (QoS) feedback; the Real-Time Streaming Protocol (RTSP), as described in RFC 2326, for controlling delivery of streaming media; the Session Description Protocol (SDP), as described in RFC 2327, for describing multimedia sessions; and the Session Announcement Protocol (SAP) for advertising multimedia sessions by multicast.

In further embodiments, other standards for establishing real-time interactive call sessions may also be used. Another standard is the H.323 Recommendation from the International Telecommunications Union (ITU), which describes terminals, equipment, and services for multimedia communications over data networks.

The network elements 42, 44, and 30 in FIG. 1 may be SIP client systems or SIP server systems. A SIP client system may include a client application program that is capable of sending SIP requests to perform call requests. The SIP server system may include an application program that accepts SIP requests to service calls and to send back responses to SIP requests. Thus, each of the SIP systems 42, 44, and 30 may be a SIP client when initiating a SIP call session and a SIP server. When responding to a SIP call request the local networks 14 and 16 may also include SIP proxy systems 46 and 48, respectively. A SIP proxy system may include an intermediary program that acts as both a server and a client for making requests on behalf of other clients. In one embodiment, the service provider system 54 may also be a SIP proxy system.

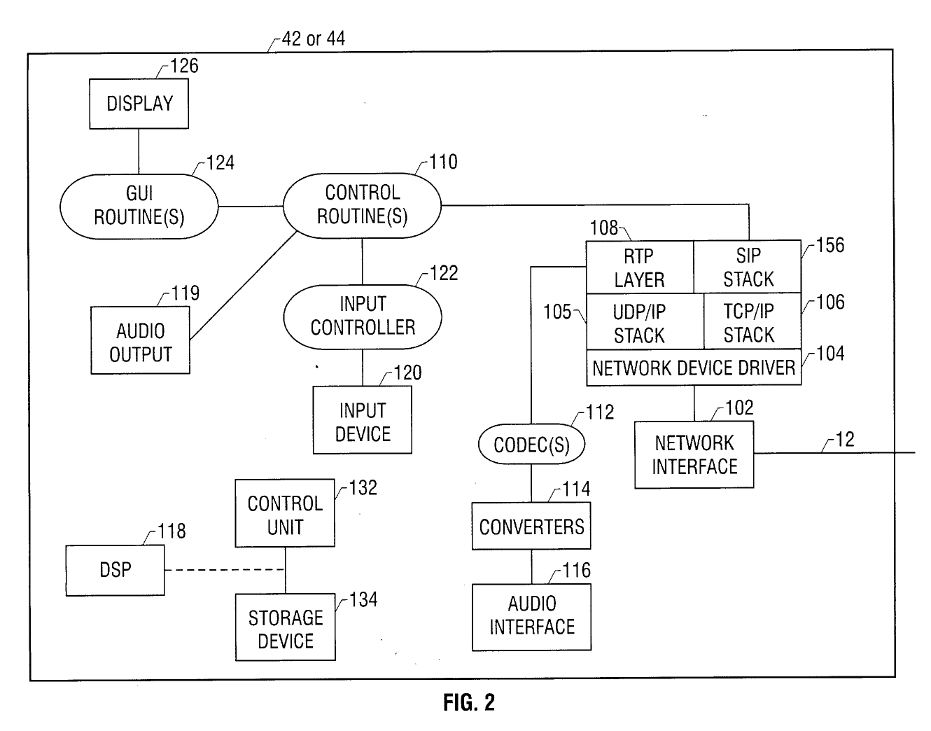

Referring to FIG. 2, the components of a subscriber system (e.g., 42 and 44) are illustrated in greater detail. The subscriber system includes a network interface 102 that is coupled to the data network 12. Above the network interface 102 are several software layers, including a device driver layer 104, transport and network stacks 105 and 106 (e.g., TCP/IP and UDP/IP stacks), and an RTP layer 108. TCP is described in RFC 793, entitled “Transmission Control Protocol,” dated September 1981; and UDP is described in RFC 768, entitled “User Datagram Protocol,” dated August 1980. TCP and UDP are transport layers for managing connections between network elements on an IP network. In further embodiments, other types of transport and network stacks may be used.

Packets received by the network interface 102 are passed up through the several layers 104, 106, and 108. Control packets are transmitted by the TCP/IP or UDP/IP stack 105 or 106 to one or more software control routines 110 in the subscriber system. Instructions and data associated with the control routines 110 may be stored in a storage device 134, with the instructions executable on a control unit 132. The control routines 110 are responsible for generation of control signaling for participating in communications over the data network 12.

In addition, the control routines 110 may include application programs that may be launched to present advertising information. For example, an audio player application (for audio data), a video player application (for video data), and/or a browser (for markup language files including text data) may be launched to present advertising information on a display screen 126 or an audio output 119 (e.g., speakers). The advertising information may thus be presented on one of, or some combination of, the presentation devices listed above or other presentation devices.

Audio data (e.g., voice data) may be passed through the UDP/IP stack 105 and the RTP layer 108 to a speech processing application, which may also be executable on the control unit 132. For faster processing of voice data, a digital processor (DSP) 118 may be included in the subscriber system to implement a decoder/encoder (CODEC) for converting encoding and decoding audio signals and data.

The display screen 126 in the subscriber system may also be used to display information associated with a call session as well as provide call control selectors to enable a user to perform call control, under the control of one or more graphical user interface (GUI) routines 124. If the subscriber system is a telephone, telephony buttons may also be included, such as numeric buttons, speed dial buttons, a transfer button, a hold button, a redial button and other buttons.

The SIP stack 156 is responsible for processing SIP message communications over the data network 12. The SIP stack 156 is in communication with the one or more control tasks 110. The SIP stack 156 is generally a state machine that provides parsing, processing, and generation of SIP requests and responses.

The mobile device 30 (FIG. 1) may include similar components as the subscriber systems 42 and 44 except that its interface is to a wireless link 34. Layers specific to generation and receiving of control signaling in a cellular communications network are also included in the mobile device 30.

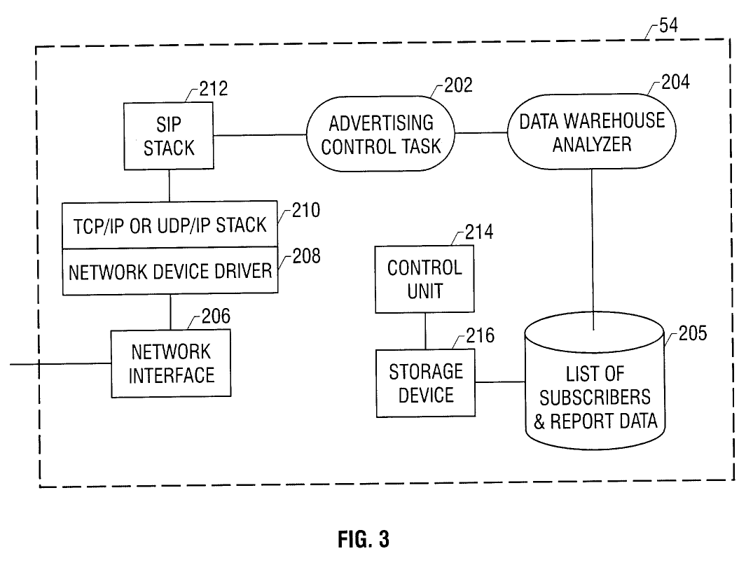

Referring to FIG. 3, the service provider system 54 includes an advertising control task 202 and a data warehouse analyzer 204, which may be application layer programs. The service provider system 54 also includes a list of subscribers and associated data (e.g., advertising information) 205. The advertising control task 202 manages the communication of advertising information to subscriber systems associated with subscribers. The data warehouse analyzer task 204 analyzes the report data (which includes advertising information) received from the data warehouse source 56 to identify the content of the advertising information to be sent to specified subscribers or users. The data warehouse analyzer task 204 may also determine when the advertising information is to be sent. The advertising control task 202 may then package the identified advertising information for transmission at the specified time using messaging according to a real-time interactive call protocol such as SIP or H.323. The service provider system 54 is able to access the data warehouse source 56 over the data network 12 to retrieve desired report data generated by the data warehouse source 56.

The service provider system 54 includes a network interface 206 coupled to the data network 12. Above the network interface 206 is a network device driver layer 208, a TCP/IP or UDP/IP stack 210, and a SIP stack 212. The software layers in the service provider system 54 are executable on a control unit 214. The control unit 214 is coupled to a storage device 216, which may store, among other things, the list of subscribers and associated data warehouse report data.

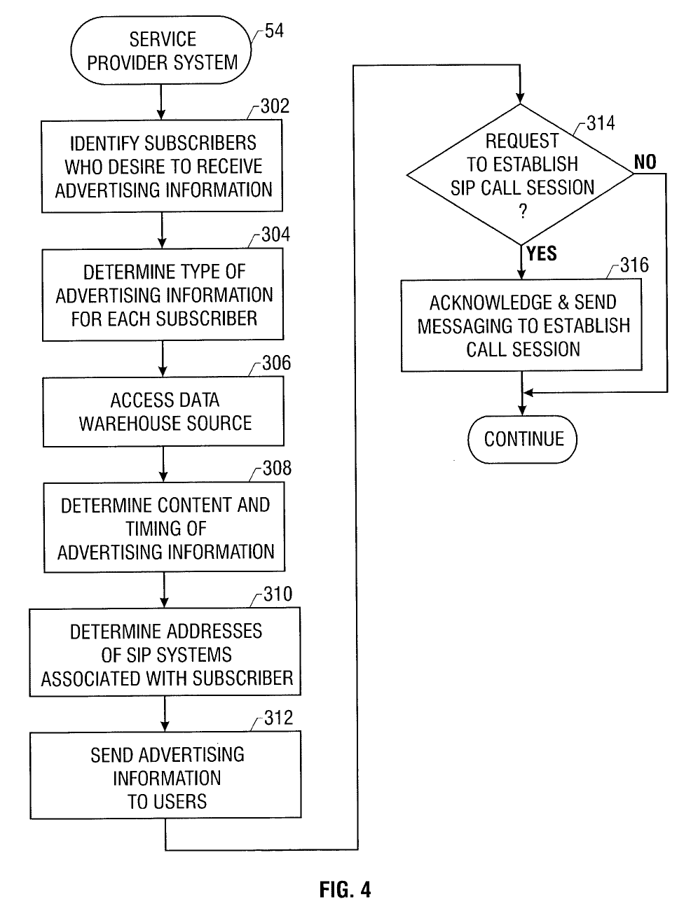

Referring to FIG. 4, some acts performed by the service provider system 54 are illustrated. The advertising control task 202 may identify (at 302) subscribers who desire to receive advertising information. This may be maintained as a list of subscribers stored in the storage device 216 of the service provider system 54. Next, the advertising control task 202 determines (at 304) the types of advertising information of interest to each subscriber. A subscriber may specify, for example, interest in advertising information for particular types of products or services. Alternatively, no particular types of products or services are specified so that all advertising information that may be of interest to the user (such as based on prior transactions) may be selected. The data warehouse analyzer 204 can then access (at 306) the data warehouse source 56 to collect the desired information. The data warehouse source 56 may maintain report data containing advertising information that are of interest to identified subscribers or users. For example, the report data may have plural sections, with each section associated with a specific user and containing advertising information associated with that user.

After receipt of the report data from the data warehouse source, the data warehouse analyzer 204 may determine (at 308) the content and timing of advertising information for each subscribers who desires to receive advertising information. Once the advertising control task determines that advertising information is to be communicated, the advertising control task 202 then determines (at 310) the addresses of one or more subscriber systems associated with each subscriber. The advertising information is then sent (at 312) to the determined addresses.

Next, the advertising control task 202 determines (at 314) if a request to establish a SIP call session has been received. When a subscriber receives advertising information, he or she may wish to find out more about the advertised products or services. Locator information of the advertising source, which may be in the form of an address (e.g., a SIP address) or uniform resource locator (URL) may be included with the advertising information. In one embodiment, the advertising information which may be in Hypertext Markup Language (HTML) format, for example. The embedded address may be selected by the user to establish a call with the source of the advertised products or services. If a request to establish a call session is received, the advertising control task 202 acknowledges the request and sends (at 316) appropriate messaging to establish the desired call session, as further described below.

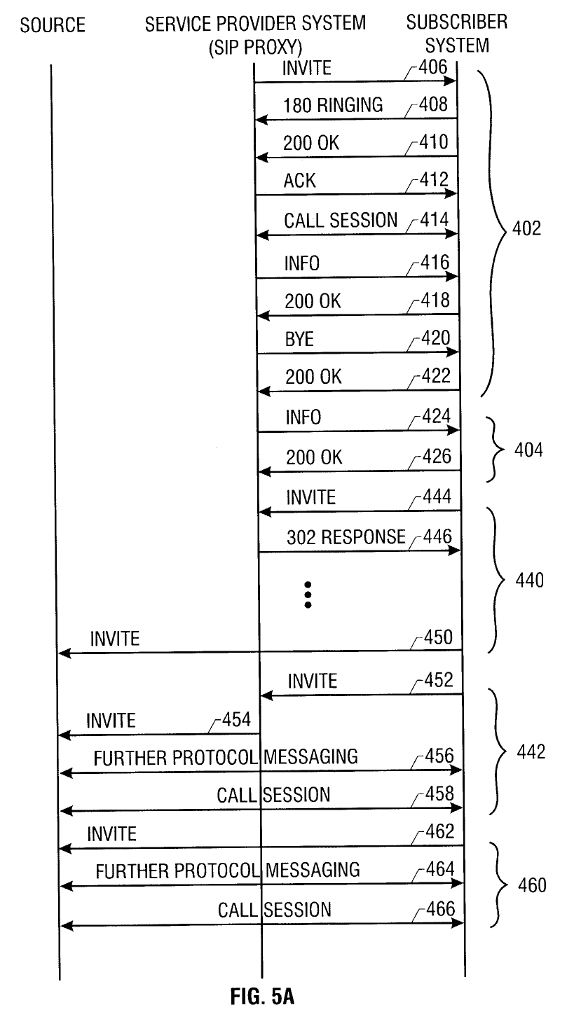

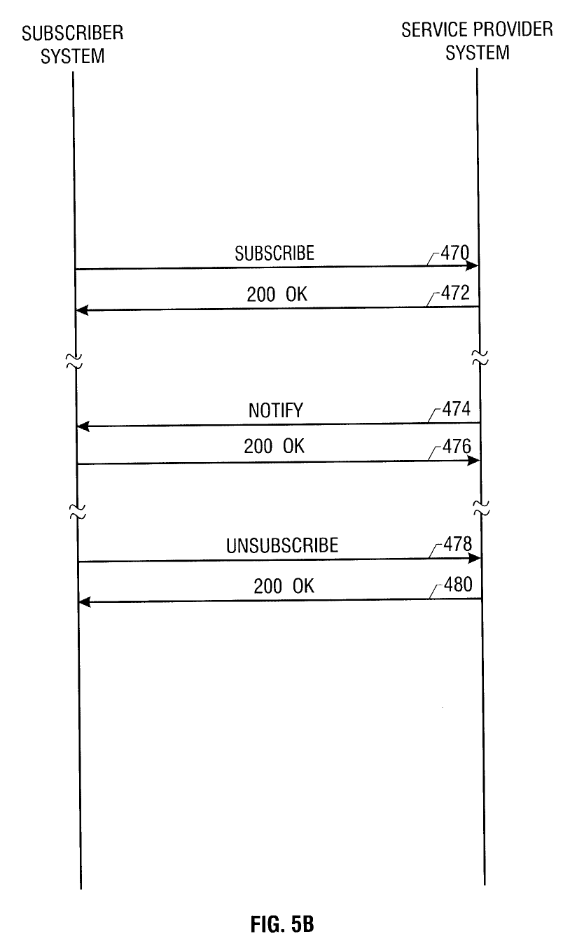

Referring to FIGS. 5A-5B, example message flows involving the data warehouse source 56, service provider system 54, and subscriber system is illustrated. The example flows are SIP messaging flows. In further embodiments, other protocols such as H.323 may be employed. There are at least two techniques for the service provider system 54 to send the advertising information to a subscriber. The first technique is illustrated in a call flow 402, and the second technique is illustrated in a call flow 404.

In the call flow 402, the service provider system 54 sends an Invite request (at 406) to the subscriber system. The Invite request is defined by SIP and indicates that the receiving node is being invited to participate in a call session. Based on the “From:” field in the Invite request, the subscriber system may determine that the requested session may be one in which advertising information is to be communicated. Special processing may be performed by the subscriber system because of the presence of advertising information. For example, the subscriber system receiving the Invite request may not activate an audio ring indicator on the subscriber system (unlike with other calls in which a ring is provided to the user to notify the user of an incoming call). Such a scheme may be provided to avoid a bothersome ring indicator for advertising information. The user may also configure the subscriber system to either allow audio ringing or not to allow audio ringing when receiving of an Invite request pertaining to advertising information.

Before acceptance of the call request, the subscriber system issues a SIP Ringing response (at 408). Once the call is accepted, the subscriber system may send a SIP OK response (at 410) to the service provider system 54 to indicate that the request has succeeded. The service provider system 54 then sends (at 412) an Ack request confirming that the service provider system 54 has received a final response to an Invite request. Upon receipt of the Ack request, further exchanges of protocol messaging establishes a call session (at 414) in which advertising information is to be communicated.

Once the call session has been established, one or more Info messages may be sent (at 416) from the service provider system 54 to the subscriber system. The Info messages may be SIP messages that carry application-level information along a SIP signaling path, which is the signaling path established as a result of a SIP call setup. This may be either direct signaling between the calling and called systems or a signaling path involving a SIP proxy server. Multiple Info messages allow for a stream of advertising information (such as downloads of multiple text, graphics, and audio files or pointers to such files), which provides for flexibility in presentation of the advertising information.

Upon receipt of each Info message, the subscriber system may send an OK response (at 418) back to the service provider system 54. Once the advertising information has been communicated, the service provider system may send a Bye request (at 420) to terminate the call session. The subscriber system then returns an OK response (at 422) back to the service provider system 54.

In an alternative technique of communicating advertising information from the service provider system 54 to the subscriber system, the second call flow 404 may be employed. In this alternative embodiment, the Info message may be communicated outside of a call session (out-of-band Info message) between the service provider system 54 and the subscriber system. In this alternative embodiment, the Info message may be defined by a version of SIP or it may be defined outside of SIP. Upon receipt of the Info message (at 424), the subscriber system may respond (at 426) with some type of an acknowledgment. If the Info message is defined by SIP, the acknowledgment may be an OK response. If the Info message is defined outside of SIP, some other acknowledgment may be provided, such as messages according to the Hypertext Transport Protocol (HTTP).

The advertising information sent to the subscriber system may include locator information, such as a SIP address or a uniform resource locator (URL), that the subscriber system may call if a user is interested in further information. Several different techniques of establishing such a call session may be possible, with three techniques illustrated in example call flows 440, 442,and 460. The call flow 440 illustrates a SIP redirect flow, in which the subscriber system is directed to call another location (which may be the source of the advertising information). The call flow 442 illustrates a SIP proxy flow, in which the service provider system acts as a SIP proxy and forwards the call request. The call flow 460 is one in which the subscriber system contacts the source of the advertising information.

In the call flow 440, the subscriber system sends an Invite request (at 444) to the address specified in the advertising information. This may be in response to the user selecting the address in an HTML page displayed at the subscriber system or the user pressing a preselected button. To redirect the call, the service provider system may send back a SIP 302 response message, for example, that contains the address information of the source of the advertising material to the subscriber system. The 302 response indicates that the subscriber system should retry the request. The subscriber system then issues an Invite request (at 450) to the source of the advertising information to establish a call session between the subscriber system and the advertising source.

In the second technique of establishing a call session between the subscriber system and the advertising source, the subscriber system can send an Invite request to the service provider system 54. In response to the Invite request, the service provider system then sends an Invite request (at 454) to the advertising source. In this technique, the service provider system 54 has effectively forwarded the call to another number. After exchange of further protocol messaging among the advertising source, the service provider system, and the subscriber system, a call session is established (at 458) between the advertising source in the subscriber system.

In a third technique for establishing a call session between the subscriber system and the advertising source (call flow 460), the subscriber system can send an Invite request (at 462) directly to the advertising source (using the address or URL specified in the advertising information). In this third technique, the service provider system 54 as intermediary is avoided. After further protocol messaging exchanges between the advertising source and the subscriber system (at 464), a call session is established (at 466) between the advertising source and the subscriber system.

In accordance with another technique, a subscribe/notify mechanism may be used to provide advertising information to a subscriber system. Subscribe and Notify requests have been proposed as an extension to SIP to provide a framework by which SIP nodes can request notification from remote nodes concerning various events. As an example, a subscribe and notify technique is described in an Internet Draft entitled “Event Notification in SIP,” dated March 2000. The Subscribe request may be used to request notification of an event or set of events at a later time. The Notify request may be used to notify a SIP node that an event which has been requested by an earlier Subscribe request has occurred. In addition, an Unsubscribe request may be used to indicate that the node which previously sent a Subscribe request no longer wishes to be notified of the event or set of events.

As shown in FIG. 5B, the subscriber system sends a Subscribe request (at 470) to the service provider system, which returns an OK response (at 472). The Subscribe request may indicate that the subscriber system wishes to receive advertising information relating to various goods or services. Some time later, the service provider system may send one or more Notify requests (at 474) to the subscriber system. The one or more Notify requests may contain the requested advertising information. To correlate the Subscribe and Notify requests between the subscriber system and the service provider system, the Subscribe and Notify requests sent at 470 and 474 may contain the same call identifier (call-ID) and uniform resource identifiers (URIs). In response to receipt of each Notify request, the subscriber system sends back an OK response (at 476). If the subscriber system is no longer interested in the subscribed advertising information, the subscriber system can send an Unsubscribe request (at 478) to the service provider system. The service provider system then sends back an OK response (at 480).

More effective techniques are thus provided to communicate advertising information to users. Some embodiments of the invention employ the use of data warehousing techniques to gather the purchasing patterns of a given customer to determine the types of products and services that are most appealing to the given customer. This type of information may then be used to determine the advertising that would be most effective for the customer. The identified advertising information may then be communicated to one or more systems associated with the user at scheduled times. This provides more directed and more effective advertising with likely higher success rate for purchases of the advertising goods or services by the end user.

The service provider system may also bill the source of advertising information based on the calls made by subscribers to inquire further about advertised goods and services. Such billing may be a flat rate or it may be on a per call basis. Thus, as the service provider system receives call requests from subscribers, it tracks the call requests. The tracked calls are then used to generate billing information.

The following provides an example of how some embodiments may be employed. A customer may purchase new carpeting for his or her house. This purchase is then fed to an information repository (e.g., the data warehouse source 56) and re-sold to the service provider. The service provider feeds this information into its database system. Through data warehousing analysis, the service provider system may note that three or four months later after the purchase was made, the customer may be interested in a carpet cleaning service. Advertising for one or more carpet cleaning services, perhaps tailored to the type of carpet purchased, may then be communicated and displayed on one or more SIP client devices associated with the customer. The customer, in a hurry to leave on vacation, may have had an accumulation of dirt built up on the carpet since its purchase. When the customer uses his or her subscriber system to make an unrelated phone call, the customer may notice the advertisement for the carpet cleaner on the display. By clicking on some predetermined selector provided with the advertising information (e.g., “contact us”), a call session can immediately be placed between the customer and the source of the advertising information.

In another embodiment, a customer may have gone on vacation to some destination. Such information is then disseminated to the data warehouse source 56 and finally to the service provider system 54. Some time later, the service provider system 54 may provide advertisement for another possible vacation destination of similar cost to the customer.

As noted above, the various network elements coupled to the data network 12 may include several software layers, routines, or modules. Such software layers, routines, or modules are executable on corresponding control units. The various control units in the network elements (such as in the subscriber systems 42, 44, and 30, the service provider system 54, and in other systems) may each include a microprocessor, a microcontroller, a processor card (including one or more microprocessors or microcontrollers), or other control or computing devices. As used here, a “controller” may refer to software, hardware, or a combination of both.

The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Instructions that make up the various software routines, modules, or layers in the various network elements may be stored in respective storage devices. The instructions when executed by a respective control unit cause the corresponding network element to perform programmed acts.

The instructions of the software routines, modules, or layers may be loaded or transported to the network element in one of many different ways. For example, code segments including instructions stored on floppy disks, CD or DVD media, a hard disk, or transported through a network interface card, modem, or other interface device may be loaded into the system and executed as corresponding software routines, modules, or layers. In the loading or transport process, data signals that are embodied in carrier waves (transmitted over telephone lines, network lines, wireless links, cables, and the like) may communicate the code segments, including instructions, to the network element. Such carrier waves may be in the form of electrical, optical, acoustical, electromagnetic, or other types of signals.

While the invention has been disclosed with respect to a limited number of embodiments, those skilled in the art will appreciate numerous modifications and variations therefrom. It is intended that the appended claims cover all such modifications and variations as fall within the true spirit and scope of the invention.

What is claimed is:

1. A method of establishing a call session over a network, comprising:
receiving multimedia information associated with a source, the multimedia information including locator information associated with the source, the multimedia information further containing advertising information;
sending, in response to user input, a request based on the locator information to establish a real-time interactive call session with the source.

2. The method of claim 1, wherein the receiving and sending are performed in a subscriber system.

3. The method of claim 1, wherein the multimedia information relates to a product or service, the method further comprising setting up the real-time interactive call session between the subscriber system and the source to provide a user with further information regarding the product or service.

4. The method of claim 3, wherein setting up the real-time interactive call session includes establishing a telephony call session.

5. The method of claim 3, wherein setting up the real-time interactive call session includes establishing an audio and/or video conferencing session.

6. The method of claim 1, wherein sending the request includes sending a Session Initiation Protocol message.

7. The method of claim 6, wherein sending the Session Initiation Protocol message includes sending an Invite request.

8. The method of claim 1, further comprising submitting a request to receive the multimedia information.

9. The method of claim 1, wherein receiving the multimedia information includes receiving multimedia information generated by a data warehouse source.

10. The method of claim 1, further comprising receiving an indication to redirect the request to another location.

11. The method of claim 1, further comprising a proxy forwarding the request to another location.

12. A method of communicating over a network, comprising:
receiving multimedia information from a source;
identifying multimedia information for a given user; and
sending, over the network, Session Initiation Protocol messaging to one or more subscriber systems associated with the given user, the Session Initiation Protocol messaging containing the identified multimedia information, the multimedia information comprising advertising information.

13. The method of claim 12, wherein receiving the multimedia information includes receiving the multimedia information from a data warehouse source.

14. The method of claim 12, further comprising establishing one or more call sessions with the one or more subscriber systems and communicating the Session Initiation Protocol messaging containing the identified multimedia information in the one or more call sessions.

15. The method of claim 14, wherein establishing the one or more call sessions includes establishing Session Initiation Protocol call sessions.

16. The method of claim 15, wherein communicating the Session Initiation Protocol messaging containing the identified multimedia information includes communicating one or more Session Initiation Protocol Info messages containing the identified multimedia information.

17. The method of claim 12, further comprising receiving a request from a subscriber system to establish a call with the source.

18. The method of claim 17, further comprising sending an indication back to the subscriber system to retry the request at another location.

19. The method of claim 17, further comprising forwarding the request to another location.

20. The method of claim 17, further comprising tracking the request to enable billing.
